(19) United States
(12) Patent Application Publication
(10) Pub. No.: US 2014/0137832 A1
(43) Pub. Date: May 22, 2014

(54) SEALING SLEEVE

(71) Applicant: Björn HEED, Gothenburg (SE)

(72) Inventor: Björn HEED, Gothenburg (SE)

(73) Assignee: HEED CONSULTING AB, Goteborg (SE)

(21) Appl. No.: 14/038,261

(22) Filed: Sep. 26, 2013

Related U.S. Application Data
(63) Continuation of application No. 13/138,040, filed on Jun. 27, 2011, now abandoned.

(30) Foreign Application Priority Data
Jan. 26, 2009 (SE) 0900073-8

(51) Int. Cl. F02F 3/00

(52) U.S. Cl. CPC F02F 3/00
USPC 123/193.4

(57) ABSTRACT

A sealing sleeve for sealing between piston and cylinder wall in internal combustion engines with a height in the direction of piston movement that is at least three times as large as its width in the radial direction of the cylinder having a pressurised annular cut out (6 in FIG. 2) in that outer surface of it that contacts the cylinder wall.

### CROSS-REFERENCE TO RELATED APPLICATIONS

This application is a continuation of U.S. application Ser. No. 13/138,040 filed on Jun. 27, 2011, which is a National Stage Application of App. No. PCT/SE2010/050056 filed on Jan. 21, 2010, which claims priority to Swedish App. No. 0900073-8 filed on Jan. 26, 2009, the contents of each of which is incorporated by reference in their entirety.

### BACKGROUND OF THE INVENTION

### Related Art

In internal combustion engines with reciprocating pistons working inside cylinders it is essential that there is a good seal between the piston and the cylinder wall. This seal is usually accomplished by so called piston rings resting in grooves on the piston circumference. The gas pressure inside the cylinder forces the piston ring both against the cylinder wall and against one side of the piston groove. The clearances between the piston ring and the cylinder wall and between the piston ring and the piston groove side thus both become small. This works as a seal and reduces the gas leakage.

The gas pressure inside the cylinder can be rather high, especially so in engines operated with increased inlet air pressure accomplished by compressors or turbo chargers. The high gas pressure results in a correspondingly high contact pressure between the piston ring and respectively the piston and the cylinder wall. The latter manifests itself in friction opposing movement of the piston in the cylinder. This friction can be quite substantial, even if it is reduced by the application of lubrication oil, and it lowers the engine's energy efficiency. It also causes local heat generation, which may harm the lubrication and cause wear and severely limit operating time between overhauls and shorten total life expectancy of the engine. As the friction depends on contact force and thus on both cylinder gas pressure and geometrical size this local heating effect is more pronounced in large engines.

### SUMMARY OF INVENTION

According to the present invention the friction between the piston seal and the cylinder wall can be reduced. This will increase the energy efficiency of the engine and also reduce wear and increase the time between overhaul and lengthen the life expectancy of the engine. Central to the invention is the realisation that sealing between the piston seal and the cylinder wall is dependant of the contact pressure there, while the friction is dependant on the contact force. A reduction of the contact area reduces friction even if contact pressure is kept constant.

### BRIEF DESCRIPTION OF THE DRAWINGS

FIG. 1 is a conventional piston ring;

FIG. 2 is a sealing sleeve, in accordance with an example embodiment;

FIG. 3 is a detailed view of the sleeve of FIG. 1, in accordance with an example embodiment;

FIG. 4 is an alternative sealing sleeve, in accordance with an example embodiment; and

FIG. 5 is another alternative sealing sleeve, in accordance with an example embodiment.

### DETAILED DESCRIPTION

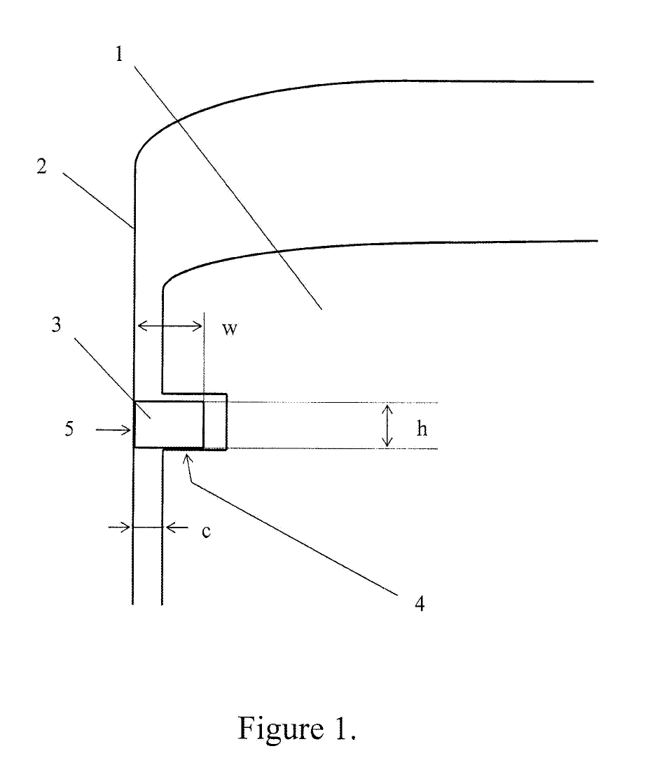

In FIG. 1 a conventional piston ring is shown and some relevant geometrical measures depicted. In this figure that represents part of a mid section through a cylinder and its piston, 1 is the piston, 2 is the cylinder wall, 3 is the piston ring, 4 is the piston ring-piston groove sealing area and 5 the piston ring-cylinder wall sealing area.

In an idealised and simplified analysis supposing non-warping bodies and where the gas pressure difference across the piston ring is P the following can be seen (measures as depicted in FIG. 1):

a) Solid to solid contact pressure between piston ring and piston groove (area 4) is equal to:

P·(w−(w−c)/2)/(w−c)>P/2

which gives good contact and a good seal.

b) Solid to solid contact pressure between piston ring and cylinder wall (area 5) is equal to:

P/2

which also gives a good seal.

c) Friction between piston ring and cylinder wall:

P·h·l·u/2 (where u is the friction coefficient and l is the circumferential length of the cylinder wall)

The pressure of the gas oil mixture in the sealing slot is supposed to change linearly from one end to the other. Forces due to springiness of the piston ring are disregarded.

From c it is apparent that the friction and also the friction per circumferential length of piston ring is dependent on the piston ring height h. The smaller this can be made, the smaller the friction will be. More complex modelling including for instance springiness and warping of the reciprocating piston ring will not negate this conclusion.

For a conventional piston ring the height h is determined by need for the piston ring to resist warping due to pressure and friction forces. The clearance (c in FIG. 1.) between the piston proper and the cylinder wall tends to increase in proportion to cylinder bore size. To resist excessive warping the piston rings then conventionally are made bigger for larger cylinder bores even if the pressure P is not increased. The height h of the ring is conventionally made proportional to the cylinder bore diameter.

In big ships' engines the friction heat then puts high demands on the lubricating system and lubrication oil quality. A not uncommon failure mode for such engines is so called “scuffing” where the lubrication between piston ring and cylinder wall fails. This may cause severe damage to the engine.

The present invention is concerned with lowering the friction between the piston seal and the cylinder wall. One objective is then to increase the energy efficiency of the engine. A second objective is to reduce the local heating caused by friction between the piston seal and the cylinder wall and thereby improve lubrication and lifetime.

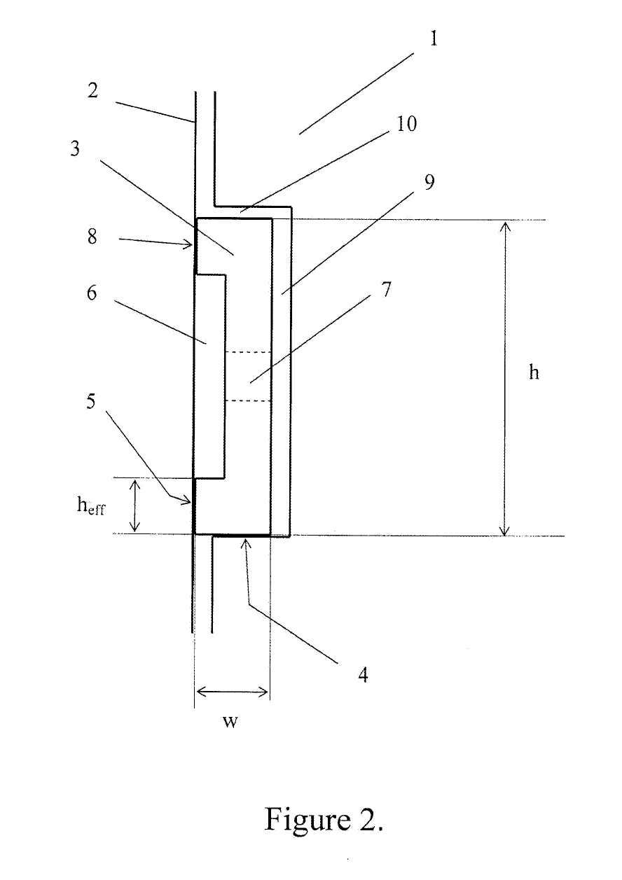

The new invention employs a sealing sleeve rather than a sealing ring. In FIG. 2. an example of such a sealing sleeve according to the present invention is shown and some relevant geometrical measures depicted. In this figure, representing a similar mid section of a cylinder and piston as in FIG. 1., 1 is the piston, 2 is the cylinder wall, 3 is the sealing sleeve, 4 is the sealing sleeve to piston groove sealing area and 5 is the sealing sleeve to cylinder wall sealing area. The high pressure is supposed to be above the piston and the sealing sleeve. At the outside part of the sealing sleeve 3 there is an annular cut out space 6. This space is connected to the backside of the sealing sleeve through several annually spaced holes 7 that allow gas pressure to be evened out between the annular cut out space 6 and the area 9 at the backside of the sealing sleeve. This area 9 is connected to the high pressure above the piston through slot 10.

In a similar simple analysis as was previously made for the conventional piston ring in FIG. 1. we get for the new sealing sleeve in FIG. 2:

a) Solid to solid contact pressure between sealing sleeve and piston groove (area 4) is equal to:

P·(w−(w−c)/2)/(w−c)>P/2

which gives good contact and a good seal.

b) Solid to solid contact pressure between sealing sleeve and cylinder wall (area 5) is equal to:

P/2

which also gives a good seal.

c) Friction between piston seal and cylinder wall:

P·h_{eff}·l·u/2 (where u is the friction coefficient and l is the circumferential length of the cylinder wall)

Since h_{eff} can be made much less than h of the conventional piston ring in FIG. 1., the friction of this sealing sleeve can be much lower. The pressure in the annular cut out space 6 is the same as on the backside of the sealing sleeve and on top of the piston. The pressure in the slot 10 can also be considered the same. The pressure difference P is thus working on only a part of the total height of the sealing sleeve. Alternatively the gas in the annular cut out space 6 can be regarded as functioning as a gas cushion that balances much of the force caused by the pressure on the inner side of the sealing sleeve.

To achieve enough resistance to warping from the forces of friction and gas pressure and still not get too much friction against the cylinder wall a conventional piston ring is made so that the width w of the ring is larger or essentially of the same size as the height h of the ring. A sealing sleeve according to the present invention can be made with a height h which is much larger than its width w. Because of the gas cushion in the cut out space 6 this can be done without causing excessive friction against the cylinder wall. A high total height makes the sleeve resistant to warping even if the width w is small.

A third objective of the present invention is to make a piston seal that can resist excessive warping while still being flexible in the radial direction and able to follow irregularities in the cylinder wall. Such an ability to adjust to a non-perfect cylinder wall reduces leakage. It also reduces the risk for abnormally high contact pressure and dangerous friction conditions at protruding cylinder wall areas. Scuffing is often initiated in such areas. The flexibility of the sealing sleeve of the present invention makes the lubrication situation more forgiving. In such engines where lubrication is accomplished by a continuous supply of fresh lubrication oil, the oil feed might then be reduced, saving operating cost.

When applying force to bend a straight beam the resulting bending (1/r, where r=bending radius) is inversely proportional to the moment of inertia of the beam cross section. This in turn is proportional to the cube of the section's height in the bending direction. For an object that is bent already from the beginning a corresponding relation applies to its deformation from original shape. A sealing sleeve according to the present invention can advantageously be made with a width w which is less than one third of the height h. Decreasing the width w to one third while keeping other circumstances constant will change the moment of inertia of the cross section to 1/27 of its original value. The force needed to adjust the sealing sleeve to irregularities in the cylinder wall will thus be reduced by a factor of 27. This without a need to change from conventional and proven materials of construction.

A piston seal made according to the present invention may preferably be made with a smaller width than a conventional piston ring. For retrofit in old engines there would sometimes be an advantage if the old piston ring grooves could be used even with the new sealing sleeves of smaller width. This can be accomplished by using a non-working ring placed inside the sealing sleeve to fill the empty space and keep the working sleeve in correct position. In other cases the height of outer part of the piston grooves could be increased both upwards and downwards and a new higher seal made according to the present invention fitted into the resulting higher outer groove. The sealing sleeve will then be held in place by the new groove surfaces, while remnants of the old, deeper groove, will cause no harm behind the middle of the sleeve.

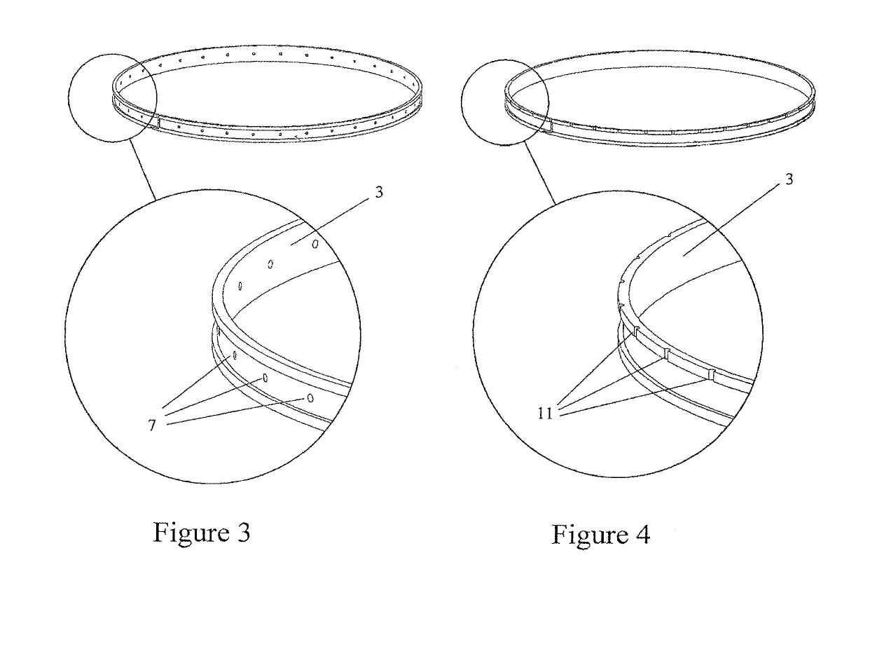

An important feature of the new piston seal is that the annular cut out (6) in the outer surface of the sleeve is in gas conveying contact with the high-pressure side of the piston. This makes the annular cut out work as a gas cushion between the sleeve and the cylinder wall. This gas cushion balances part of the force from the gas pressure working on the backside of the sleeve. In the design shown in FIG. 2 the gas connection is accomplished by holes 7 through the sleeve to the space 9 at the backside of the sleeve, this being in contact with the high pressure side of the piston through the slot 10, which forms between the sleeve and the groove side at the high pressure side of the sleeve. Alternatively, when, as usually is the case, the high pressure is always on the same side of the piston seal, such a gas conveying connection could be accomplished by a more direct route through vertical holes or vertical grooves (11) in the upper part (supposing the high pressure to be above a vertically operating piston) of the sleeve. The two alternatives are shown in FIGS. 3 and 4.

A conventional piston ring will tend to wear more at the top and the bottom and thus have a somewhat convex sealing surface. In fact such a convex or barrel-shaped outer surface is often an intentional design feature. Anyhow such a convex surface will give little support against warping of the ring from the friction and the gas pressure and the clearance between piston and cylinder. To resist warping the ring has to rely on internal stiffness and a broad width (w). In a sealing sleeve according to the present invention the situation is different. There is no convex contact surface to roll on but two different and separated contact surfaces at some distance from each other. This applies also to a worn sleeve.

The contact area 8 in FIG. 2 between the sealing sleeve and the cylinder wall has no sealing function. However as long as the contact there exists this means that the piston sleeve is in its proper orientation. While a conventional piston ring has to rely on internal stiffness not to warp, a piston seal according to the present invention is kept unwarped and supported by cylinder wall. The contact force at 8 is provided by the springiness of the sleeve helped by the tendency of the sleeve to tilt from the pressure from above and the clearance between the piston and the cylinder wall. The contact force at 5 in FIG. 2 depends directly on the action of the pressure behind the seal. The pressure thus holds both contact surfaces against the cylinder wall and the sleeve can be made quite narrow and flexible (small width w in FIG. 2) without the risk of warping.

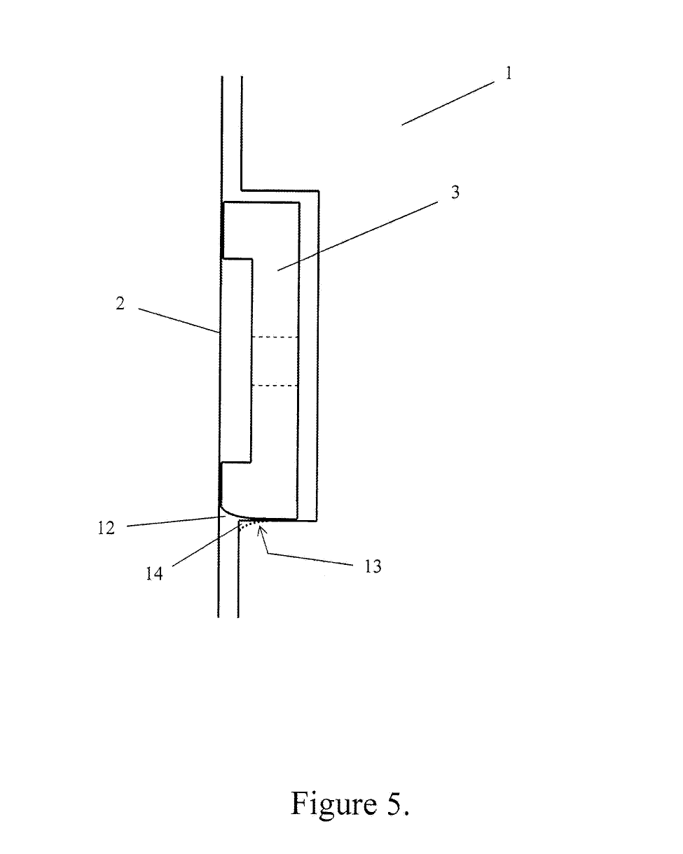

The tilting tendency can be enhanced and made independent of the clearance between piston and cylinder by removing material from the outer part of the bottom (low pressure part) of the sleeve and thereby moving the pivot point for tilting in from the edge of the groove. This is accomplished by bevelling or rounding the outer edge of the low pressure part of the sealing sleeve so that by sealing against the piston groove side its contact surface with the piston groove side ends within the piston groove. See FIG. 5 where 1 is the piston, 2 is the cylinder wall and 3 is the sealing sleeve with material removed from the bottom of the sleeve at 12, so that the pivot point for tilting 13 is moved away from the cylinder wall 2. This moving of the pivot point also lowers the risk for damage from material fatigue at the groove edge 14. Alternatively a corresponding effect can be achieved by removing material from the outer part of the groove at 14 as indicated by the dotted line in FIG. 5. In contrast to the situation with conventional piston rings such moving of the pivot point away from the cylinder wall will not increase the tendency of the seal to warp.

For simplicity in the descriptions above the situation has been described where only one sealing device has been used and the high pressure in the cylinder has worked from above. The invention is not restricted to this special case, but is equally applicable to other orientations and where several sealing devices are used in series as is usually the case with conventional piston rings. For pressure from above or pressure above the piston or the sealing sleeve then instead read pressure from or on the high-pressure side of the device.

1-4. (canceled)

5. A system, comprising:
a cylinder of a combustion engine, the cylinder having an internal wall;
a piston configured to oscillate within the cylinder, the piston having a groove with an upper edge and a lower edge;
a sealing sleeve insertable into the groove of the piston,
the sealing sleeve being configured to float within the groove, allowing the sealing sleeve to seat against the internal wall of the cylinder and the lower edge of the groove of the piston via a high-pressure fluid at a top portion of the piston that applies a fluid force acting on both a top and inner surface of the sealing sleeve during system operation,
a height of the sealing sleeve being at least three times a width of the sealing sleeve, for achievement of resistance against warping while still having flexibility and an ability to follow the cylinder wall,
the sealing sleeve having an outer surface facing the cylinder well and defining an annular cut out,
the sealing sleeve defining at least one hole or vertical groove fluidly coupled to the annular cut out to allow the fluid force acting on the top and inner surface of the sealing sleeve to pressurize the annular cut out to ensure that the fluid force on the top and inner surface of the sealing sleeve and the fluid force within the annular cut out are substantially the same during system operation.

6. The system of claim 5, wherein a first gap exists between the top surface of the sealing sleeve and an upper edge of the groove of the piston, and a second gap exists between the inner surface of the sealing sleeve and an inner surface of the groove of the piston, when the sealing sleeve is seated against the internal wall of the cylinder and the lower edge of the groove of the piston during system operation.

7. The system of claim 6, wherein the at least one hole or vertical groove defined by the sealing sleeve includes a hole penetrating the inner and outer surfaces of the sealing sleeve.

8. The system of claim 6, wherein the at least one hole or vertical groove defined by the sealing sleeve includes a vertical groove on an outer surface of an upper lip of the sealing sleeve that is defined by the annular cut out.

9. The system of claim 6, wherein a lower part of the sealing sleeve, facing the cylinder, is rounded or beveled.

10. The system of claim 7, wherein a longitudinal length of the annular cut out is larger than a width of the hole penetrating the inner and outer surfaces of the sealing sleeve.
